(19) United States
(12) Patent Application Publication
(10) Pub. No.: US 2006/0142140 A1
(43) Pub. Date: Jun. 29, 2006

(54) Embedding fiber improvements using ultrasonic consolidation

(76) Inventor: Dawn White, Ann Arbor, MI (US)

Correspondence Address: John G. Posa;Gifford, Krass, Groh, Sprinkle, Anderson, & Citkowski, P.C., PO Box 7021, Troy, MI, 48007-7021, US

(21) Appl. No.: 11/286,487

(22) Filed: Nov. 23, 2005

Related U.S. Application Data
(60) Provisional application No. 60/630,922, filed on Nov. 24, 2004.

(51) Int. Cl. C04B 35/52; C04B 35/46

(52) U.S. Cl. 501/99; 501/102; 501/136

(57) ABSTRACT

Fibers and layers are co-applied using ultrasonic consolidation and providing steps and/or materials to maintain collimation of the fibers. According to one preferred embodiment the mechanism is a scrim. Alternatively the mechanism may include a material having one or more fibers under a foil layer. The mechanism may further include embedding a layer of fibers in a foil in a “tacking” process, and consolidating the result with an underlying substrate. Yet a further alternative includes interspersing metal fibers between reinforcing fibers. The reinforcing fibers may include SiC, B or Al₂O₃ fibers. A different preferred method of co-applying fiber and metal using ultrasonic consolidation, comprises the steps of alternating either an encapsulation material or another metal with optical, ceramic, shape-memory, or other fibers of interest, and encapsulating the result between layers of foil.

### REFERENCE TO RELATED APPLICATION

This application claims priority from U.S. Provisional Patent Application Ser. No. 60/630,922, filed Nov. 24, 2004, the entire content of which is incorporated herein by reference.

### FIELD OF THE INVENTION

This invention relates generally to ultrasonic object consolidation and, in particular, to steps and/or materials to maintain collimation of the fibers prior to full consolidation.

### BACKGROUND OF THE INVENTION

Ultrasonic consolidation is an additive manufacturing technology used to produce objects of any geometry from uniform, featureless feedstocks, such as tapes, sheets, wires, or droplets. There are a range of methods for accomplishing the metallurgical consolidation of the feedstocks via ultrasonic energy. These include, but are not limited to, spot consolidation, continuous rotary consolidation, plate-type consolidation, and so forth.

My U.S. Pat. No. 6,519,500 is directed to a system and a method of fabricating an object by adding material layers incrementally and consolidating the layers through the use of ultrasonic vibrations and pressure. The layers are placed in position to shape the object by a material feeding unit. The raw material may be provided in various forms, including flat sheets, segments of tape, strands of filament or single dots cut from a wire roll. The material may be metallic or plastic, and its composition may vary discontinuously or gradually from one layer to the next, creating a region of functionally gradient material. Plastic or metal matrix composite material feedstocks incorporating reinforcement materials of various compositions and geometries may also be used.

If excess material is applied due to the feedstock geometry employed, such material may be removed after each layer is bonded, or at the end of the process; that is after sufficient material has been consolidated to realize the final object. A variety of tools may be used for material removal, depending on composition and the target application, including knives, drilling or milling machines, laser cutting beams, or ultrasonic cutting tools.

The consolidation is effected by ultrasonic welding equipment, which includes an ultrasonic generator, a transducer, a booster and a head unit, also called a horn or sonotrode. Ultrasonic vibrations are transmitted through the sonotrode to the common contact surface between two or more adjacent layers, which may include layers next to each other on the same plane, and/or layers stacked on top of each other. The orientation of the sonotrode is preferably adjusted so that the direction of the ultrasonic vibrations is normal to the contact surface when consolidating layers of plastic material, and parallel to the contact surface when consolidating layers of metal.

The layers are fed sequentially and additively according to a layer-by-layer computer model description of the object, which is generated by a computer-aided design (CAD) system. The CAD system, which holds the layered description of the object, interfaces with a numerical controller, which in turn controls one or more actuators. The actuators impart motion in multiple directions, preferably three orthogonal directions, so that each layer of material is accurately placed in position and clamped under pressure. The actuators also guide the motion of the sonotrode, so that ultrasonic vibrations are transmitted in the direction required through the common contact surfaces of the layers undergoing consolidation.

My issued U.S. Pat. No. 6,685,365, the entire content of which is incorporated herein by reference, discloses a continuous, single-step, low-temperature process combines metal coating with the splicing of fibers. Reference is made to the drawings wherein, beginning with FIG. 1A, a foil sheet 102 acts as the base material for the connector. Although aluminum is used in the preferred embodiment, other suitable metals, alloys and plastic/ceramic-based materials may be used. Applicable metals include aluminum, copper, titanium, nickel, iron and their alloys as well a numerous other metals of more limited structural utility.

Optical fibers 104 to be fixtured are precisely placed on the foil surface. The foil substrate may be featureless or features may be etched in the foil surface for use as a guide to locate the fibers. A precision fiber placement system may also be used to locate the fibers on the foil substrate. A second layer of foil 106 is placed over the foil/fiber assembly, as shown in FIG. 1B.

As shown in FIG. 1C, an ultrasonic welding system is used to consolidate the assembly. Application of the ultrasonic energy on aluminum, for example, has the effect of reducing the flow stress, allowing it to plastically deform uniformly around the fibers. In addition, where the two layers come into contact in the interfiber spacing, welds together, as it would if the fibers were not present. This has the effect of producing a bonded optical fiber, with uniform stress applied to it, and a hermetic interfiber seal. The bonds can be produced using stationary welding tools, or rotating welding tools, depending on the number and length of the fibers to be bonded, and the desired geometry of the splice. Single or multiple layers splices can be produced.

Additional layers of fibers can be added to the first layer, by precisely positioning additional fibers, and covering them with a further layer of foil prior to consolidation, producing a single, continuous low-cost process for embedding fibers in metal, and/or the splicing of fibers with a joint featuring uniform composition and high strength requiring no additional adhesives. The method can be used to create terminations for cables, or it can be used as a method of splicing or joining optical fibers by positioning the ends of the two fibers under the foils, so that they abut prior to creating the bond. The consolidation material may be provided in sheets, with or without fiber-locating grooves or, alternatively, droplets may be used.

### SUMMARY OF THE INVENTION

This invention resides in co-applying fibers and layers using ultrasonic consolidation and providing steps and/or materials to maintain collimation of the fibers. According to one preferred embodiment the mechanism is a scrim. Alternatively the mechanism may include a material having one or more fibers under a foil layer. The mechanism may further include embedding a layer of fibers in a foil in a “tacking” process, and consolidating the result with an underlying substrate. Yet a further alternative includes interspersing metal fibers between reinforcing fibers. The reinforcing fibers may include SiC, B or Al₂O₃ fibers. A different preferred method of co-applying fiber and metal using ultrasonic consolidation, comprises the steps of alternating either an encapsulation material or another metal with optical, ceramic, shape-memory, or other fibers of interest, and encapsulating the result between layers of foil.

### BRIEF DESCRIPTION OF THE DRAWINGS

FIG. 1A is a drawing which shows the use of a foil sheet acting as a base material for an optical connector;

FIG. 1B shows how a second layer of foil is placed over the foil/fiber assembly of FIG. 1A;

FIG. 1C depicts how an ultrasonic welding system is used to consolidate the assembly of FIG. 1B;

FIG. 2 shows how a scrim may be used to hold fibers in position until ultrasonic consolidation occurs;

FIG. 3 illustrates how a layer of fiber-including material is applied simultaneously according to a different aspect of the invention; and

FIG. 4 shows metal fibers are interspersed between reinforcing fibers (such as SiC, B, Al₂O₃) in a collimated fiber system, so that the metal fibers act to make it easier to achieve full density while consolidating them with foil, at relatively higher fiber volumes.

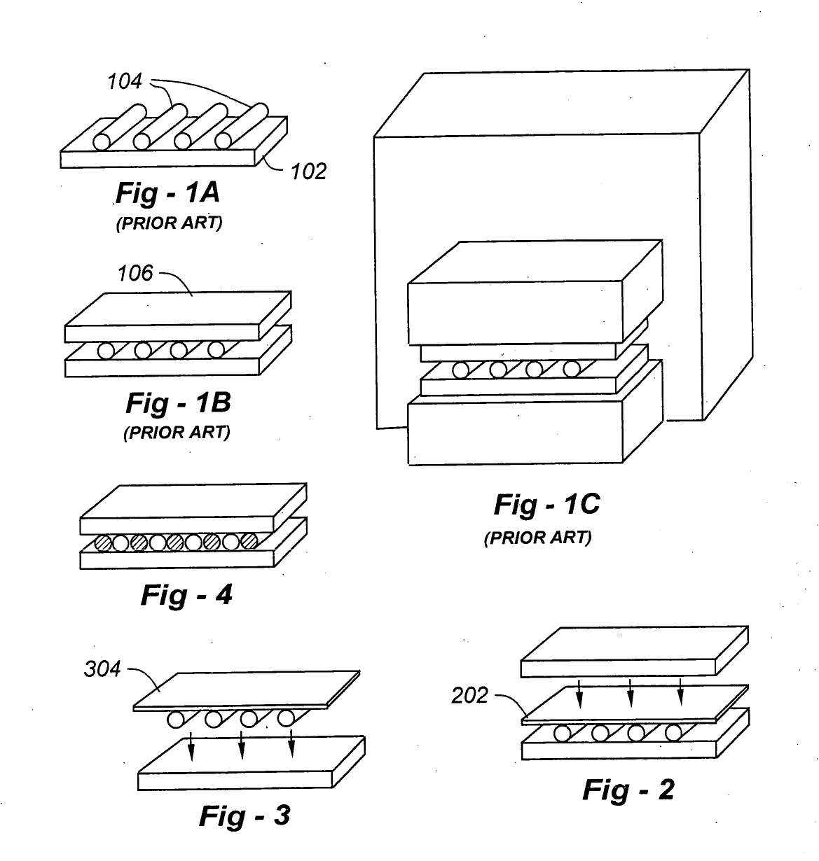

### DETAILED DESCRIPTION OF THE INVENTION

This invention resides in improved methods of embedding fibers between layers of metals alloys or other materials using ultrasonic consolidation (UC). The preferred embodiments are particularly directed to problems associated with embedding particularly fragile fibers, achieving high fiber volumes, developing dissimilar metal compositions between fibers, reducing the forces required, and various other improvements, certain of which are patently distinct.

According to one aspect of the invention associated with co-applying fiber and metal, a scrim is used to maintain collimation of a fiber or metal wire-fiber assembly prior to consolidating it with foil layers via UC. The scrim 202 in FIG. 2 may be of any suitable metallic or non-metallic material having a roughened or other surface operative to hold fibers in position until ultrasonic consolidation occurs. For example, a fine metal or alloy mesh may be appropriate for such purpose.

According to a different aspect of the invention, a layer of fiber-including material is applied simultaneously. As shown in FIG. 3, the fiber lays under a foil layer 304, and is applied directly. The invention further anticipates partially embedding a layer of fibers in a foil in a “tacking” process to get a layer of fibers slightly embedded in a layer of foil to hold them there while placing the compacted foil/fiber elements on a surface, and fully consolidating them to underlying layers.

According to a further aspect of the invention, metal fibers are interspersed between reinforcing fibers (such as SiC, B, Al₂O₃) in a collimated fiber system, so that the metal fibers act to make it easier to achieve full density while consolidating them with foil, at relatively higher fiber volumes. This is shown in FIG. 4.

In all embodiments, metal fibers of either the encapsulation material or another metal can be alternated with the optical, ceramic, shape memory, or other fibers of interest, and these can be encapsulated by the layers of foil. This allows the ceramic, optical, etc. fibers to be completely encapsulated without requiring as much metal flow from the foils to object consolidation.

The methods described herein find numerous applications in various industries, particularly the aerospace and aircraft industries, since structural elements may be added to base substrates, with fibers, resulting in direct production of multiple and composite materials.

1. A method of co-applying fibers and layers using ultrasonic consolidation, comprising the steps of:
providing fibers and layers of material to be consolidated;
providing a mechanism to maintain collimation of the fibers prior to consolidation; and
ultrasonically consolidation the fibers and layers.

2. The method of claim 1, wherein the mechanism is a scrim.

3. The method of claim 1, wherein the mechanism includes a material having one or more fibers under a foil layer.

4. The method of claim 1, wherein the mechanism includes embedding a layer of fibers in a foil in a “tacking” process; and
consolidating the result with an underlying substrate.

5. The method of claim 1, wherein the mechanism includes interspersing metal fibers between reinforcing fibers.

6. The method of claim 5, wherein the reinforcing fibers include SiC, B or Al₂O₃ fibers.

7. A method of co-applying fiber and metal using ultrasonic consolidation, comprising:
alternating either an encapsulation material or another metal with optical, ceramic, shape-memory, or other fibers of interest, and
encapsulating the result between layers of foil.
